(19) United States
(12) Patent Application Publication
(10) Pub. No.: US 2007/0152157 A1
(43) Pub. Date: Jul. 5, 2007

(54) Simulation arena entity tracking system

(75) Inventor: David Wayne Page, Cocoa, FL (US)

Correspondence Address: STERNE, KESSLER, GOLDSTEIN & FOX P.L.L.C., 1100 NEW YORK AVENUE, N.W., WASHINGTON, DC, 20005, US

(73) Assignee: Raydon Corporation, Daytona Beach, FL (US)

(21) Appl. No.: 11/593,066

(22) Filed: Nov. 6, 2006

Related U.S. Application Data
(60) Provisional application No. 60/733,254, filed on Nov. 4, 2005.

(51) Int. Cl. G01J 5/02

(52) U.S. Cl. 250/340

(57) ABSTRACT

A system and method employing visual tracking devices to locate simulation players and objects within an enclosed space. These visual tracking devices capture a perspective view of the arena and analyze the image at a fixed perception frame rate. Each player and object to be tracked is identified by a light-emitting device called a tracking point source, which is identified in the environment by means of a unique code sent out by the device and received by the visual tracking device. By using multiple tracking point sources, the invention may not only determine positions but also determine the orientation (relationship) between players and objects. A third component in the invention performs frame-to-frame analysis of all visible point sources to determine motion in three dimensions, which is forwarded to the simulation environment where it is used to enmesh the player in the simulation.

### CROSS REFERENCE TO RELATED APPLICATION

This application claims the benefit of U.S. Provisional Application No. 60/733,254, filed on Nov. 4, 2005.

### BACKGROUND OF THE INVENTION

1. Field of the Invention

This invention relates to tracking the position and motion of one or more entities in a three-dimensional space as part of a training or simulation environment.

2. Background Art

As understood in this document, a simulation is a physical space in which real people and/or real objects may move, change location, possibly interact with each other, and possibly interact with simulated people and/or simulated objects (whose presence may be enacted via visual projections, audio emissions, or other means) typically in order to train for, prepare for, experience, analyze, or study real-life, potentially real-life, historical, or hypothetical situations, activities, or events. Simulations may be conducted for other purposes as well, such as educational or entertainment purposes, or for analyzing and refining the design and performance of mechanical technologies (such as cars or other transportation vehicles, weapons systems, etc.). The simulation as a whole may also be understood to include any technology which may be necessary to implement the simulation environment or simulation experience.

A simulation may be conducted in an environment known as a simulation arena (or simply as an arena, for short). Realistic simulations of events play a key role in many fields of human endeavor, from the training of police, rescue, military, and emergency personnel; to the development of improved field technologies for use by such personnel;

to the analysis of human movement and behavior in such fields as athletics and safety research. Increasingly, modem simulation environments embody simulation arenas which strive for a dynamic, adaptive realism, meaning that the simulation environment can both provide feedback to players in the environment, and can further modify the course of the simulation itself in response to events within the simulation environment. It may also be desirable to collect the maximum possible amount of data about events which occur within the simulation environment.

For a simulation to be maximally dynamic and adaptive, the technology (which may be a combination of hardware and software) controlling the simulation arena requires information on activity within the simulation environment. An essential component of this information is data on the location and movement of entities-people and objects-within the simulation environment.

Further, the more specific the location and movement data which may be obtained, the more detailed and refined can be the simulation response. For example, it is desirable to obtain information not only on where a person might be located, but even more specific information on where the person's hands, head, or feet might be at a given instant. A location granularity on the order of feet or meters is highly desirable, and even more fine-grained location discrimination (such as on the order of inches or centimeters) is desirable as well. It is further desirable to be able to determine the orientation in space of people and objects, as well as their rotational motion.

A further goal of simulation environment monitoring is to be able to distinguish between specific entities within the simulation environment, so that each real person and each real object has a unique identity within the environment, and so that the location, movement, and simulation history of each real person and real object may be tracked effectively. Yet a further goal is to provide person/object location tracking in real-time, so that adaptive responses may be provided in real-time as well.

However, obtaining detailed information on the location and movement of entities in a simulation environment offers significant technical challenges. One possible means of tracking is to simply monitor the environment via a video camera or multiple video cameras, and use computer-based analysis to track the movements of people and objects. However, a typical simulation may involve dozens or possibly hundreds, even thousands of real people and real objects, all of which must be tracked. The real-time automated analysis of complex visual data is an art-form still in its infancy; achieving a detailed delineation and tracking of the location and movement of dozens or hundreds of entities using only computer analysis of video images may not be cost-effective in terms of the amount of computing power required, Moreover, using this technology to achieve acceptable entity-identification reliability, acceptable location-determination reliability, real-time processing, or a combination of the above, may be difficult as well.

A means to achieve the desired goal is to physically attach, to the simulation participants (i.e., to the real persons and real objects within the simulation arena), some kind of signal emitting or signal receiving technology which can assist in the identification and location monitoring of the participants. (Simulation participants may also be known as “entities”.)

As one example of this approach, a global positioning system (GPS) monitor may be attached to simulation participants, enabling a determination of their location via the GPS system. However, GPS monitors may be bulky and expensive, and also may not provide the desired degree of location resolution. Another approach may be to attach radio-frequency (RF) emitters to the simulation participants, wherein nearby RF monitoring devices may detect the RF emissions and so do location determinations. However, due to the long wavelengths of RF emissions, and also due to other factors related to RF behavior in small, object-filled environments, obtaining location data by this means may not be reliable either. Similarly, other means of entity location determination, such as audio signaling, pose significant technical challenges as well.

Given the foregoing, what is needed is a method and system for determining the position of entities in a simulation environment, wherein the position and movement of each unique entity can be uniquely tracked. What is further needed is a method and system for accomplishing this goal which provides a high degree of both spatial and time resolution, so that detailed location and movement tracking of each entity may be accomplished. What is further needed is a method and system of entity location determination and entity movement tracking in a simulation environment which is cost-effective, and which is unobtrusive in terms of its impact on entities within the simulation environment.

### SUMMARY OF THE INVENTION

This invention uses energy-emitting tracking point sources (TPSs) to identify the location and motion of entities (persons and objects) within a simulation environment, where the TPSs typically emit light in the infrared ranges. By modulating the TPSs in a distinguishing manner, each TPS may be uniquely identified. The TPSs are viewed by each of a plurality of visual tracking devices (VTDs), wherein the VTDs record activity in a sequential series of short periodic time intervals known as perception frames. By correlating location-related data from multiple VTDs, it is possible to determine the three-dimensional location of the uniquely identified TPSs. Further processing then determines a path and an equation of motion of each TPS.

By performing this process using hundreds of TPSs, the motion and orientation of entities in an arena may be discerned for each perception frame. The motion and orientation of each TPS in an arena may then be used for any of a variety of purposes including, for example and without limitation, updating head mounted display views, determining weapon aim-points, or determining locations of physical obstacles in a virtual world. This system may also be employed, for example, for tracking objects or players in sports events, analyzing dance choreography, and facilitating analysis of other multi-body three-dimensional motion problems.

### BRIEF DESCRIPTION OF THE DRAWINGS/FIGURES

The features and advantages of the present invention will become more apparent from the detailed description set forth below when taken in conjunction with the drawings in which like reference numbers indicate identical or functionally similar elements.

Additionally, the left-most digit of a reference number identifies the drawing in which the reference number first appears (e.g., a reference number ‘310’ indicates that the element so numbered first appears in FIG. 3). Additionally, elements which have the same reference number, followed by a different letter of the alphabet or other distinctive marking (e.g., an apostrophe), indicate elements which are the same in structure, operation, or form but may be identified as being in different locations in space or recurring at different points in time (e.g., reference numbers ‘110a’ and ‘110b’ may indicate two different energy detection devices which are functionally the same, but are located at different points in a simulation arena).

FIG. 1A and FIG. 1B illustrate an arena where a simulation event takes place, and where energy-emitting tracking point sources (TPSs) attached to entities (people or objects) are used to monitor entity motion in the arena.

FIG. 2 is a flow chart showing the overall process of determining the identity, location and movement of an entity in an arena according to one embodiment of the present invention.

FIG. 3 illustrates a method for the computation of the location of a TPS in the arena, where the TPS is in the field of view of a visual tracking device (VTD) which is mounted in the arena to monitor TPSs, according to one embodiment of the present invention.

FIG. 4A and FIG. 4B together illustrate a method for locating a TPS in a VTD field of view, and hence for identifying an angle of incidence of a ray of light from a TPS relative to the backplane of the VTD, according to one embodiment of the present invention.

FIG. 5 illustrates how two VTDs together may determine a substantially localized region in space in which a TPS may be located, according to one embodiment of the present invention.

FIG. 6 illustrates a process for tracking the location of a moving TPS over time, according to one embodiment of the present invention.

FIG. 7A and FIG. 7B illustrate two different embodiments of a synchronous energy modulation scheme which may be used to uniquely identify a TPS.

FIG. 8A and 8B illustrate two different embodiments of an isochronous energy modulation scheme which may be used to uniquely identify a TPS.

FIG. 9 illustrates how various aspects of the present invention, such as location identification, path tracking, and object identification, may work in combination with each other in one possible embodiment of the invention.

Further embodiments, features, and advantages of the present invention, as well as the operation of the various embodiments of the present invention, are described below with reference to the accompanying figures.

### DETAILED DESCRIPTION OF THE INVENTION

An embodiment of the present invention is now described with reference to the figures. While specific configurations and arrangements are discussed, it should be understood that this is done for illustrative purposes only. A person skilled in the relevant art(s) will recognize that other configurations and arrangements can be used without departing from the spirit and scope of the invention. It will be apparent to a person skilled in the relevant art that this invention can also be employed in a variety of other systems and applications.

Overview

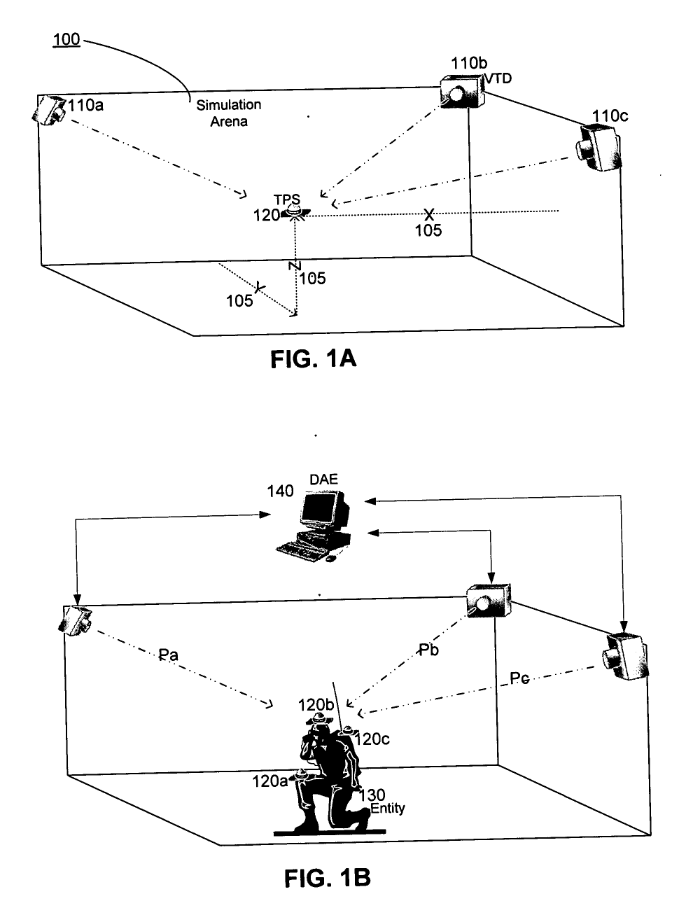

FIG. 1A and FIG. 1B illustrate an arena 100, which is defined as a bounded region of space which may be either indoors or outdoors, with a plurality energy detection devices 110 which may be video cameras or other visual monitoring devices 110. These visual monitoring devices 110 are mounted in such a way that each one of the visual monitoring devices 110 has a field of view which at least partially overlaps with the field of view of at least one other of the plurality of visual monitoring devices 110. These visual monitoring devices 110 are referred to, in the present context, as visual tracking devices 110 (VTDs), and may be mounted in the periphery, or the interior, or both the periphery and interior, of a bounded volume of space to be monitored. FIG. 1 illustrates an exemplary embodiment only, in which only three VTDs 110 are in use, but this is for purposes of illustration only. More VTDs 110 may be used, and the locations of the VTDs are not limited to the upper comers of an arena.

The terms or acronyms “energy detection device”, “visual monitoring device”, “visual tracking device”, “VTD”, and the plurals thereof, will be used interchangeably and synonymously throughout this document. It should be understood that an energy detection device, visual monitoring device, visual tracking device, or VTD 110 may encompass at least the capabilities for obtaining a time-series of images as typically embodied by a standard video camera. However, it should be further understood that an energy detection device, visual monitoring device, visual tracking device, or VTD 110 may embody other capabilities or modified capabilities as well. These capabilities may include, for example and without limitation, the ability to obtain image data based on energy in the infrared spectrum or other spectral ranges outside of the range of visible light; the ability to modify or enhance raw captured image data; the ability to perform calculations or analyses based on captured image data; the ability to share image data or other data with other technologies over a network or via other means; or the ability to emit or receive synchronization signals for purposes of synchronizing image recording, data processing, and/or data transmission with external events, activities, or technologies.

Other enhanced capabilities, adaptations, or modifications of an energy detection device, visual monitoring device, visual tracking device, or VTD 110 as compared with a standard video camera may be described further below in conjunction with various embodiments of the present invention.

The arena 100 is generally understood as the bounded volume of space wherein a simulation or gaming event may be conducted, wherein the boundaries may be defined by walls or other delimiters or markers, and wherein substantially all or most of the bounded volume of space will be monitored by the plurality of VTDs 110. However, the arena 100 may also be understood to be defined topologically as the set of all points which are visible to two or more VTDs 110, since at least two VTDs 110 may be needed to identify the location of an entity 130 in the arena.

An arena 100 may be created for the purposes of establishing an environment for human training or human event simulation, or for the testing of technologies which may be directly human controlled, remote controlled, or entirely automated, or for other purposes. FIG. 1A also shows how a coordinate system 105 may be imposed upon the arena 100 for the purpose of identifying the location of TPSs 120 within the arena. A conventional Cartesian X-Y-Z coordinate system 105 is illustrated, but other coordinate systems may be used including, for example and without limitation, a spherical coordinate system or a cylindrical coordinate system.

As shown in FIG. 1B, in operational use an arena 100 will contain at least one entity 130, such as a person or object 130, and possibly multiple persons or objects 130, wherein it is expected that the person or object 130 will be in motion within the space of the arena 100 at some point in time. FIG. 1B shows a person 130, sometimes referred to in the art as a “player”, who may be in motion. For simplicity, the remainder of this document typically refers simply to an entity 130 or entities 130, it being understood this term refer may refer to persons, animals, plants, inanimate objects, or any kind of entity 130 which may be in motion within the arena 100. The terms “person”, “object”, “device”, or “player” or the plurals thereof may be employed as well, and will be understood to be interchangeable with “entity” or “entities”.

Attached to an entity 130 may be at least one tracking point source (TPS) 120. Shown in FIG. 1A and FIG. 1B are four TPSs 120; the three TPSs 120a, 120b, and 120c in FIG. 1B are attached to the figure of the person 130 (and may not be drawn exactly to scale in relation to the person); the TPS 120 of FIG. 1A is shown unattached to any entity, which may not typically be the case in the normal course of operations of the invention. However, in an embodiment of the present invention a stationary TPS 120 or stationary TPSs 120 may be attached to walls or boundaries, or placed at other fixed locations in the arena 100 or near the arena 100 for a variety of purposes including, for example and without limitation, boundary delineation, VTD 110 perception frame synchronization (perception frames and synchronization are discussed further below), VTD 110 error checking or VTD 110 calibration, as a further means for or supplement to other means for distance determinations or angular determinations, or for other purposes.

It should be further understood that while not every entity 130 in the arena may have a TPS 120 attached, any entity 130 whose motion is of interest may have at least one TPS 120 attached to it. Attaching more than one TPS 120 to an entity 130 may allow for detection of entity 130 orientation or angular motion.

A TPS 120 is a source of energy emission, which may be an energy emitting device which is physically small compared to the physical size of the entity 130. The terms or acronyms “source of energy emission”, “tracking point source”, “TPS”, and the plurals thereof are used interchangeably and synonymously in this document.

The actual energy-emitting component itself, which may be only one component of the source of energy emission 120, may be small enough to be considered as substantially a point source of light. The energy emitted by the TPS 120 may be infrared light, or possibly light in some other frequency range. The light emitted by the TPS 120 may be in the visible light range; however, this poses the possibility of interference caused by normal room lighting unless special steps are taken to prevent this. Therefore, it may be preferred to have the TPS 120 emit light outside the range of light frequencies used to illuminate the arena 100. The light emitted by the TPS 120 falls in a frequency range which can be detected by the VTDs 110. In one embodiment of the present invention, each VTD 110 may be limited to sensing light emissions in an energy range beyond human perception (e.g., 780-960 nm), and hence the light emitted by the TPSs 120 would fall in this range as well.

A TPS 120 will at a minimum be comprised of an element or component (already referred to above) for emitting electromagnetic energy, a means for powering the electromagnetic energy-emitting component, and a means for modulating the emissions of the electromagnetic energy-emitting component. In one embodiment of the present invention, the electromagnetic energy-emitting component may emit infrared light. In another embodiment of the present invention, the electromagnetic energy-emitting component may emit light in the visible range. For the sake of brevity, in the remainder of this document we may speak of a “light-emitting component”, an “infrared emitting element”, an “IR emitting element”, or similar terms, along with “light emissions” and similar terms; but nothing in this terminology should be understood as limiting the frequency or wavelength of electromagnetic energy which may be emitted by the electromagnetic energy-emitting component.

Each TPS 120 may internally store its identity, i.e., the unique modulation pattern for its energy emission, and may possess a means for said storage such as an internal memory chip. A TPS 120 may have a hard-coded, fixed modulation pattern, or a TPS 120 may be programmable to upload into the TPS 120 different modulation patterns. In turn, this identity (that is, the unique modulation pattern) may be registered with the system, for example, with a data analysis engine (DAE) 140, prior to the start of operations of a simulation. The DAE 140 is discussed further below.

The size of the TPSs 120 can be small enough to allow an entity 130 in the arena 100 to be identified by multiple TPSs 120. This may allow a single TPS 120 to be used to identify position alone, while two TPSs 120 may provide 3-d orientation. A TPS 120 may be implemented using an infrared (IR) emitter and a micro-processor. Alternatively, a TPS 120 may be implemented using an IR emitter and a programmed logic array. A TPS 120 may also be implemented using an IR emitter and a memory cell used to store and replay an identity message (that is, an energy emission modulation pattern, discussed further below) through the IR emitter. A TPS 120 may have other components, as well, such as a means for synchronization with the VTDs 110, also discussed further below.

In one embodiment of the present invention, each TPS 120 has a single light-emitting component. In an alternative embodiment of the present invention, a single TPS 120 may have two or more light-emitting components, which may be used for such purposes as determining an orientation of the TPS 120, providing a means to obtain light from one light-emitting component when another light-emitting component is temporarily occluded from view of a VTD 110, or for other purposes. If a TPS 120 has more than one light-emitting component, each such component may emit light at the same frequency or may emit light at a different frequency from the others, and each such component may be modulated using the same energy modulation pattern or may be modulated using a different energy modulation pattern from the others.

TPSs 120 are attached to and physically tag entities 130 to be tracked in the arena 100. A TPS 120 may be attached to the tracked entity 130 using a variety of means of attachment including, for example and without limitation, tape, glue, Velcro™, screws, bolts or gum. A TPS 120 may be permanently integrated into a device 130 for use in an arena 100 tracking environment. TPSs 120 may be enhanced using other location or movement detection technologies including, for example and without limitation, accelerometers, magnetometers, or GPS equipment, which may detect orientation of a device 130 in the arena 100 environment, or which may supplement the location information provided by the method of the present invention.

In general, a VTD 110 may use a video-camera based technology to detect the TPSs 120. A VTD 110 may alternatively use a solid-state imager-based technology to detect the TPSs 120. Note that a VTD 110 may be a multi-imager VTD (not shown), having two or more energy sensors separated by some distance, e.g., 10 cm. This may provide stereoscopic determination of distance, in addition to perspective angles.

Alternatively, distance can be determined by triangulation, using two or more physically separate VTDs 110, as discussed further below.

Collectively, the VTDs 110 in the arena are referred to as the VTD array. In FIG. 1A, multiple VTDs 110 in the VTD array are used to locate a TPS 120 in the arena in each of three dimensions X, Y, and Z. VTDs 110 are arranged so as to give overlapping coverage of the space. The orientation and perspective of each VTD 110 may be designed to provide maximum coverage of the available space, resulting in the largest possible volume of locations where TPSs 120 may be in view of the VTDs 110; or may be designed to ensure the highest probability that a TPS 120 will always be within the field of view of at least two VTDs 110, or possibly more than two VTDs 110, to ensure optimum TPS 120 tracking; or the orientation and perspective of the VTDs 110 may be designed to provide a balance between maximum spatial coverage and maximum likelihood of optimum TPS 120 tracking. Other design considerations may be a factor as well in the placement or orientation of VTDs 110.

For reduction of a three-dimensional fix, a minimum of two VTDs 110 perspectives is necessary. Once a fix has been made on the location of a TPS 120, the system builds a three-dimensional path model. Once a path model is established a TPS 120 may be tracked using one or more VTDs 110. These details are discussed further below.

A final element of the overall invention is a data analysis engine (DAE) 140, which is a computer or analogous computational device or centralized processing unit which integrates and analyzes data from the VTDs 110 in the VTD array to determine the motion of entities 130 within the arena. DAE 140 may be networked to both the VTDs 110 and an arena host computer system (pot shown).

The DAE 140 may be local to each arena if there are multiple arenas in use, and may perform four main tasks:

The first task may be matching TPS lists from multiple VTDs into multiple perspective views per TPS. A TPS list may be a VTD-specific list of all TPSs 120 which have been within the field of view of a VTD 110, and which may be found within the field of view of the same VTD 110 in upcoming perception frames. As discussed further below, establishing a TPS list may entail demodulating the modulated light emission from each TPS 120. (Alternatively, demodulation of the TPS identities may be performed at each VTD independent of the DAE 140; this task may be performed by each VTD 110, which may employ onboard processing and memory, and which may also maintain its own TPS list.)

The second task may be to build 3-dimensional motion formulas for all known TPSs 120 in the system.

The third task may be to build up lists of unidentified TPSs 120 for future identification. Since TPSs are occluded in some perspectives or completely occluded for short periods, DAE 140 may determine both a projected solution, i.e., an anticipated position, direction, and equation of motion of known but occluded TPSs 120, as well as a potential best fit for all solutions. These projected locations, directions, and equations of motion may be matched up against the list of unidentified TPSs 120 to determine if an unidentified TPS 120 is, above some threshold of probability or likelihood, a known TPS 120 which has been recaptured by the tracking system.

A fourth DAE 140 task may be to communicate data concerning entity locations and movement to an arena host computer system (not shown). The arena host computer system may use the data for a variety of purposes including, for example and without limitation, maintaining a history of entity 130 location and movement; reporting on entity 130 location and movement; modifying, in response to entity 130 location and movement, visual displays or auditory feedback presented to simulation players; or modifying, in response to entity 130 location and movement, elements or aspects of the arena environment, or other aspects of the simulation.

It may be that most or all of the computational tasks of the present invention are performed by the DAE 140, though some may be offloaded to other elements, such as the VTDs 110 or TPS 120. (For example, identification of TPSs 120 may be performed by the DAE 140, or may be performed in whole or part by the VTDs 110.) In some embodiments of the present invention, the DAE 140 may perform additional tasks as well.

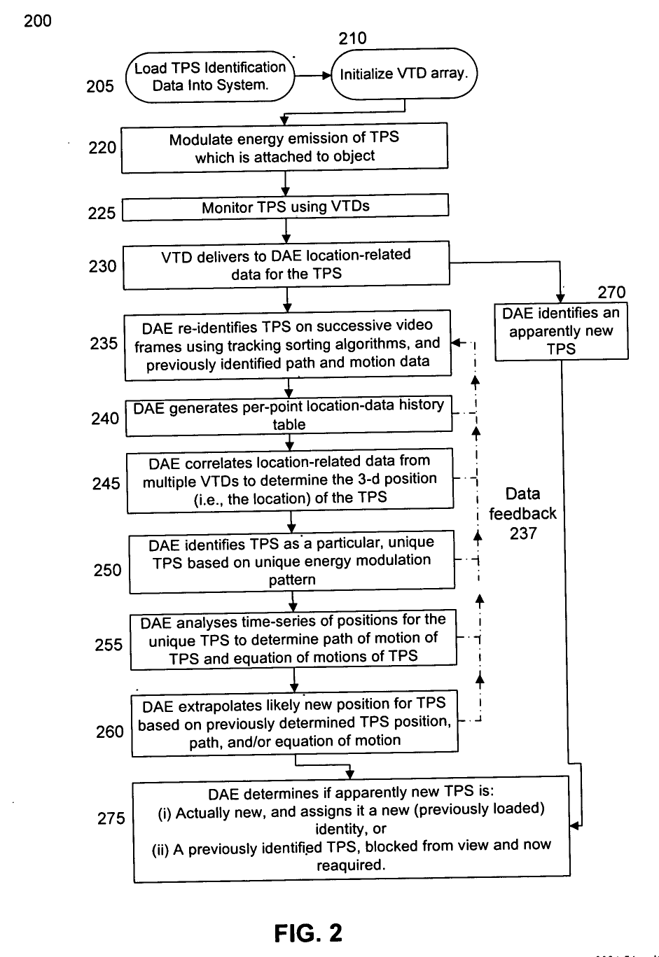

FIG. 2 is a flow chart showing the overall process of identifying the movement of an entity according to one embodiment of the present invention. The overall steps are described here in general terms, with more details being provided in later discussion.

Steps 205 and 210 are initialization steps pertaining to both the TPS modulation and VTD array initialization.

In one embodiment of the present invention, it is typically expected that more than one TPS 120 will be used, either because more than one entity 130 is being tracked, or because orientation as well as position of an entity 130 is being tracked, or for a combination of these reasons. In order to track the position and motion of more than one TPS 120, it is necessary that the TPSs 120 attached to the entity or entities 130 can be uniquely identified. This is accomplished by having each TPS 120 emit light according to a modulation pattern which is unique among all the TPSs 120 in the system. This modulation pattern is the “identity message” referred to above, and the two terms will be used interchangeably in this document.

The modulation scheme, in turn, has an implementation which relies on the fact that the VTDs 110 capture motion via successive images called “frames”, or “perception frames”. The VTDs 110 image (i.e., perform image capture of) the arena scene at a periodic rate called the perception rate. Typical video or solid state imaging technology may capture images at a rate on the order of 15 to 30 frames per second, although a faster or slower perception rate may be used. The inverse of the perception rate may be the length of each perception frame; in one embodiment of the present invention, the VTDs 110 may have a perception frame with a duration of 1/16^{th} of a second. All VTDs may share the same, constant perception rate and may have perception frames of the same duration.

The modulation scheme of the present invention works by having a TPS 120 emit light or not emit light (i.e., be modulated on or off, respectively) during a period of time known as an energy emission event. Note that an energy emission event is defined to embody two different types of intervals: an energy emission event may be an interval when the TPS 120 emits light, and an energy emission event may be an interval when the TPS 120 does not emit light. Put another way, an interval when a TPS 120 actually does not emit energy is defined to be one type of energy emission event.

An energy emission event may have a duration which is substantially close to, though not necessarily the same as, the duration of a single VTD 110 perception frame.

For example, in one embodiment of the present invention, if a perception frame is 1/16^{th} of a second, the duration of an energy emission event, during which a TPS 120 will either emit light or not emit light, will be substantially close to 1/16^{th} of a second. The overall modulation pattern of a TPS 120 is expressed over a plurality of energy emission events; a given TPS 120 will present the same modulation pattern repeatedly over successive pluralities of energy emission events. The details of the energy modulation pattern are discussed further below.

In step 205, TPS identification data is loaded into the system of the present invention. In some cases, this may entail initializing each TPS 120 itself with a modulation pattern. In other instances, the TPSs 120 may already have a modulation pattern built in, or stored from a previous initialization (during a previous simulation run, for example). However, it may still be necessary to program the DAE 140 or otherwise upload data into the DAE 140, so that the DAE 140 knows which modulation scheme is associated with which TPS. In other cases, it may be the case that the DAE 140 is already programmed to know which modulation scheme is associated with which TPS 120. However, it may still be necessary to program the DAE 140 or otherwise upload data into the DAE 140 to indicate which TPS 120 (and hence which modulation scheme) is associated with which entity 130. A DAE 140 may have a TPS database which stores information related to TPS 120 modulation, TPS 120 assignment to entities 130, and other pertinent TPS 120 information.

In step 210, the VTD 110 initialization is performed. As one aspect of step 210, VTDs 110 may be synchronized. If the VTDs 110 are connected to each other over a network, which may be controlled by the DAE 140, synchronization can be network based, so that all VTDs 110 are synchronized through the network. Alternatively, a synchronization message can be used to initiate and maintain synchronization. Alternatively, a master VTD 110 can modulate a localized VTD 110. In such an embodiment, VTDs 110 follow the lead of the master to determine the start of a perception frame.

In another aspect of step 210, DAE 140 may be initialized with information about the VTDs 110 in the VTD array. For example, the DAE 140 may contain a database which indicates the location of each VTD 110 in the arena, and also indicates the orientation of each VTD 110 in the arena. This information may be used by the DAE 140, in conjunction with TPS-related location information provided by the VTDs 110, to determine the location and movement over time of the TPSs 110.

In step 220, each TPS 120 modulates its energy emission according to the general scheme already described above. That is, a TPS 120 will either emit light or not emit light during an energy emission event, where an energy emission event has a duration in time which may be substantially close to, but is not necessarily the same as, the duration of a perception frame of a VTD 110. Each such energy emission event may also correspond to a single bit in a modulation pattern.

While the energy emission events have been described above as events of emitting light or not emitting light, in an embodiment of the present invention, the duration of the “on” period or “off” period may be less than the full duration of the energy emission event. An “on” energy emission event may be comprised of the TPS 120 emitting light for more than some threshold period of time, or more than some percentage of time, during the time which may be substantially close to the length of a perception frame. An “off” energy emission event may comprise the TPS 120 emitting light for less than some threshold period of time or less than some percentage of time during the time period which may be substantially close to the length of a perception frame.

As one example, an “on” energy emission event may be comprised of the TPS 120 emitting light for more than 95% of the indicated duration in time, while an “off” energy emission event may be comprised of the TPS 120 emitting light for less than 5% of the indicated duration in time. As another example, an “on” energy emission event may be comprised of the TPS 120 emitting light for more than 75% of the indicated duration in time, while an “off” energy emission event may be comprised of the TPS 120 emitting light for less than 25% of the indicated duration in time. Other percentages or thresholds are possible as well.

In an embodiment of the present invention, an “on” emission event or an “off” emission event may also be signaled, in whole or in part, by a level of energy emitted during the energy emission event. For example, a level of energy emission greater than an on-modulation threshold level of energy may signal an on-bit in the energy modulation pattern. Similarly, if the level of energy emission during part or all of the energy emission event is maintained at below an off-modulation threshold level of energy, this may signal an off-bit in the energy modulation pattern.

In an alternative embodiment of the present invention, a single energy emission event may use varied levels of energy emission, varied frequencies of energy emission, varied phases of energy emission, varied durations of energy emissions, or varied polarizations of energy emission, or a combination of the above, to signal multiple bits in a modulation pattern. For example, in one embodiment a substantially maximum level of energy emission may signal ‘11’, a substantially zero level of energy emission may signal ‘00’, while intermediate levels of energy emission may signal ‘01’ and ‘10’. Other energy-level/bit-pattern systems may be employed as well.

Throughout the remainder of this document it is assumed, by way of an exemplary embodiment of the invention, that a single energy emission event may correspond to a single bit in an energy emission pattern, i.e., to a ‘1’ value or a ‘0’ value, but alternative embodiments are possible as described immediately above.

If an “on” energy emission event is represented as a ‘1’, and an “off” energy emission event is represented as a ‘0’, then TPSs may have modulation patterns such as ‘11111110’, ‘10101010’, ‘11110001’, and other modulation patterns. The patterns shown here are 8-bit patterns, but longer or shorter patterns may be used, provided the length of the patterns is sufficient to provide each TPS 120 with a unique modulation scheme. The modulation scheme may include error correction and validation sequences.

As will be discussed further below, the method of the present invention may employ at least two variations on the modulation scheme shown. In one variation, known as the “synchronous” modulation scheme, the timing of the TPS 120 modulation will be substantially synchronized with the perceptions frames of the VTD array. In this synchronous variation, a TPS 120 may use every energy emission event (i.e., a single period which allows for an “on” emission or an “off” emission) for a single bit of modulation. Therefore, all potentially available bits may be used for signal modulation.

In another variation, known as the “isochronous” modulation scheme, the energy emission events may be deliberately set to have a duration such that, over a plurality of such events, the energy emission events repeatedly become in phase with the VTD 110 perception frames and then out of phase with the VTD 110 perception frames. In this isochronous modulation scheme, a TPS 120 may use some energy emission events as “beacons”, wherein light is always emitted. In essence, these bits are always used to announce that some TPS 120 is present, without identifying which TPS 120 is emitting the light. The TPS 120 may then use only the remaining energy emission events for signal modulation.

In one embodiment of the isochronous modulation scheme, a TPS may use alternate energy emission events for modulation, these then being known as modulation events. The remaining alternate energy emission events are the beacon events. This corresponds to every alternate available bit being used as a modulation bit, which conveys part of the modulation pattern. In an alternative embodiment of the isochronous modulation scheme, fewer than 50% of the available energy emission events, and therefore fewer than 50% of the potentially available signaling bits, are used to convey the modulation pattern. The remaining energy emission events, i.e., greater than 50% of the energy emission events, are used to transmit light and so serve as beacon events.

In step 225, the VTDs 110 are used to monitor the TPSs 120. This step is discussed further below.

In step 230, the VTDs 110 deliver to the DAE 140 location-related data for the TPSs 120 within their field of view. If a TPS 120 can be identified as a previously identified TPS 120, the method of the present invention may continue with step 235. If a TPS 120 is flagged by VTD 110 or DAE 140 as a new TPS 120, the method of the present invention may continue with step 275 instead.

In step 235, in one embodiment of the present invention, the DAE 140 re-identifies TPSs 120 on successive video frames using tracking and sorting algorithms, which may also employ previously identified path and motion data discussed further below. In an alternative embodiment of the present invention, some or all of the re-identification of TPSs 120 on successive video frames may be performed by the VTDs 110 rather than, or in combination with, the DAE 140. In order to perform step 235, DAE 140 may receive data feedback 237 from successive steps 240, 245, 250, 255, and 260.

Note that in one embodiment of the present invention, step 235 may be skipped when the simulation is first initialized, and there may be no identified TPSs 120 to re-identify. In an alternative embodiment step 235 may be implemented from the outset; any TPS 120 identity data, if needed, may be available from preprogrammed data, or from other sources.

In step 240, in one embodiment of the present invention, the DAE 140 generates per-point (that is, per TPS 120 per VTD 110) location-data history tables. In an alternative embodiment of the present invention, some or all of the generation of the per-point location-data tables may be performed by the VTDs 110 rather than, or in combination with, the DAE 140.

In step 245 the DAE 140 correlates location-related data from multiple VTDs to determine the three-dimensional position (i.e., the location in the arena) of the TPS 120. The details of this step are discussed further below.

In step 250, in one embodiment of the present invention, the DAE 140 identifies the TPS 120 as a particular, unique TPS based on the unique energy modulation pattern of the TPS 120. In an alternative embodiment of the present invention, some or all of the identification of the TPS 120 as a particular, unique TPS based on the modulation pattern of the TPS 120 may be performed by the VTDs 110 rather than, or in combination with, the DAE 140.

In step 255, the DAE 140 analyzes time-series positions of the TPS 120 to determine a path of motion of the TPS 120 and to determine equations of motion of the TPS 120.

The entity to which the TPS 120 is attached may have multiple components or elements, which may be engaged in complex motions. In addition, multiple entities may be present in the arena, and the arena may also have structural elements of its own. As a result of all of these factors, at times the view of a TPS 120 may be obstructed by other objects, such that only one VTD 110 or no VTDs 110 may be able to view the TPS 120. Also, the modulation of the energy emission from the TPS 120 may result in the VTDs 110 and/or the DAE 140 being unable to identify or to track the TPS 120 for a period of time. In this event, in step 260 the DAE 140 extrapolates an anticipated new position for the TPS based on the previously determined TPS position, path, and/or equation of motion.

In step 270, the DAE 140 or the VTDs 110, or possibly both in combination, identify a TPS 120 which cannot be immediately identified as a successive stage in motion of a TPS 120 in step 235. The TPS 120 is then classified as an apparently new TPS 120. In step 275, the DAE 140 determines whether the apparently new TPS 120 is actually new, or whether it is a previously identified TPS 120 which had been blocked from view, or where the tracking had otherwise been lost, wherein the previously identified TPS 120 has now been reacquired. If the TPS 120 is a new TPS 120, the DAE 140 will attempt to identify it via the modulation pattern it emits, and then associate the TPS 120 with one of the TPSs 120 previously programmed into it in step 205.

It should be understood that the steps presented above represent only one embodiment of the present invention. In some embodiments, the steps may be performed in a different order, or some of the steps may be performed in parallel. In addition, other steps may be performed as well. For example, an entity 130 in the arena 100 may have two or more TPSs 120 attached to it; then, in an additional step, DAE 140 may be able to use the location data for each of the attached TPSs 120 to determine the orientation in space of the entity 130, the angular movement of the entity 130, and the angular or rotational equation of motion of the entity 130.

Locating a TPS

In each perception frame, a VTD 110 sorts out and identifies point light sources in its field of view, where the sources of the light are one or more TPSs 120. The images of point sources detected by the VTD 110 are reduced to a pair of angles for horizontal and vertical displacement from the center of the VTD 110 field of view. By combining the known positions/perspective of each VTD 110 and the angles for each TPS 120 relative to each VTD 110, the system may resolve TPS 120 coordinates in three dimensions at any given time. In what follows, it will be understood that the necessary mathematical calculations may be performed by a one or more VTDs 110, or the DAE 140, or a combination of the DAE 140 and the VTt)s 110.

The VTD 110 may be composed of an infrared sensitive image capture device coupled to a processing array, which may be on the backplane of the VTD, that detects points in the field of view which match the criteria for TPS 120 emitters. When the processing array detects a match for a TPS it uses the pixel values which compose the TPS 120 image to compute an optical centroid for that TPS 120. The centroid for the TPS is analogous to a center of mass, except that the centroid here represents a center of optical intensity for the TPS 120, instead of a center of mass. This centroid determination is performed for all TPSs 120 detected in each image frame captured by a VTD 110.

The VTD may translate the image pixel centroid into an angular measurement offset in the horizontal (α) and vertical (λ) axes. These angles may be corrected based on tables stored in the VTD to compensate for spherical asymmetries inherent in the lens systems used in digital imaging systems to create α′ and λ′. A further correction may be performed in order to convert the viewed image into arena space ordinal angles and displacements. This latter correction may be performed at the VTD 110, or may be performed at the DAE 140.

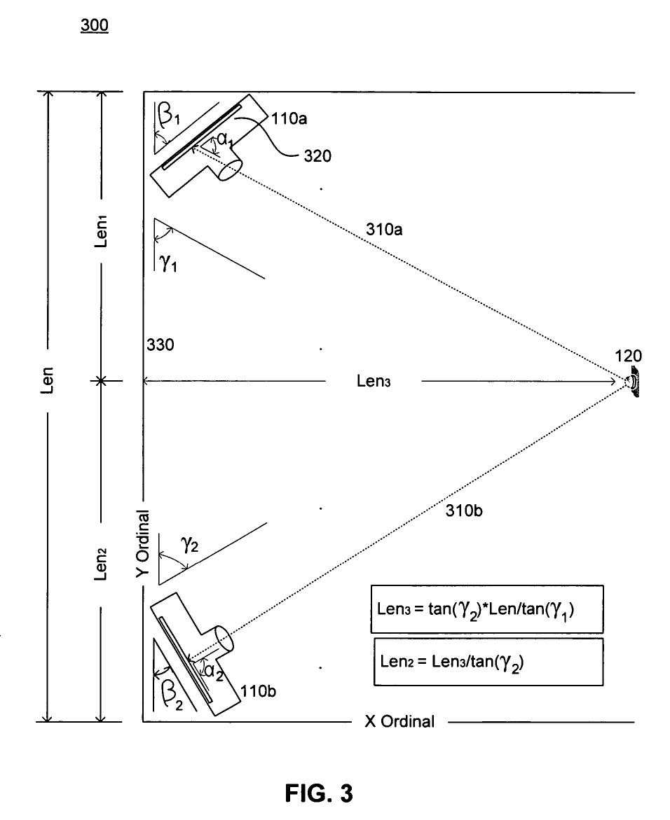

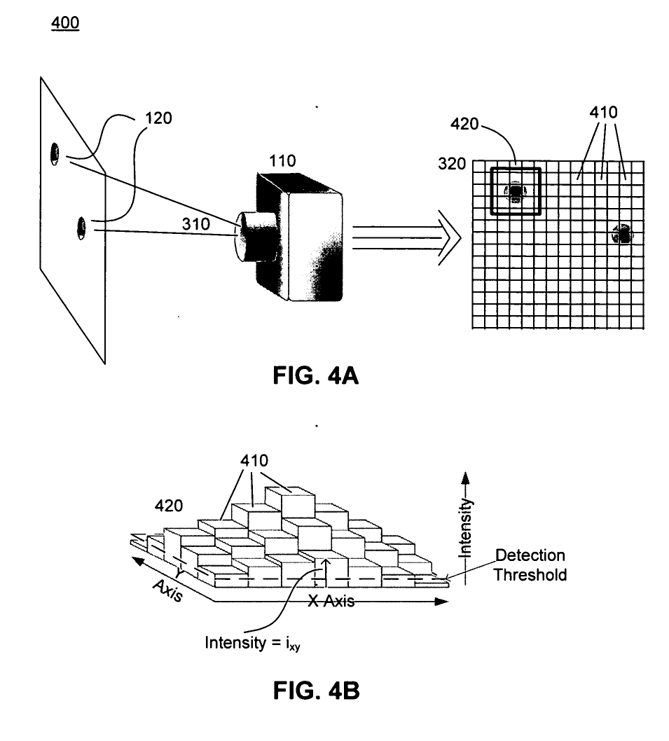

FIG. 3 illustrates a method 300 for the computation of the location of a TPS 120 in the arena 100, where the TPS 120 is in the field of view of VTDs 110. VTD 110s are installed in a fixed relationship to arena 100. The view shown is two-dimensional, and may be presumed to be a view looking up from an arena floor or down from an arena ceiling, not shown, where the view is perpendicular to the ceiling or floor (i.e., the elements seen, one TPS 120 and two VTDs 110, are as would be seen looking straight down from the ceiling or straight up from the floor). Each VTD 110 observes the arena 100 from a fixed perspective. This allows direct computation of a TPS 120 location from VTD 110 observation angles, measured as offsets from horizontal and vertical planes, of a projected ray corresponding to the TPS 120. (How the projected ray is determined by a VTD 110 is discussed further below in conjunction with FIG. 4.)

In one embodiment of the present invention, the system employs infrared light sources in each TPS 120. The light sources, i.e., the emitters within the TPSs 120, are modulated, as already discussed in general terms above (and as discussed in further detail below) to identify players and entities 130 in the arena 100. Rays of light from the TPSs 120 strike the backplanes 320 of VTDs 110 when the TPSs 120 are within the field of view of the VTDs 110. It will be understood that the backplanes 320 are the internal imaging surfaces of the respective VTDs 110, which are presumed for this embodiment of the invention to be flat, and which are further presumed to be in parallel to any VTD 110 lens which focuses light onto the backplanes. It will be understood by persons skilled in the relevant arts that if, in alternative embodiments of the present invention, the VTDs 110 employ a substantially different internal architecture (i.e., with a more complex imaging architecture, which may, for example, embody mirrors or other imaging elements as part of the focusing mechanism) than that illustrated in FIG. 3 and described herein, then suitable modifications or adaptations may be required in the exemplary calculations which follow.

In FIG. 3, α represents the angle of incidence of a ray of light 310 from a TPS 120 relative to the backplane 320 of a VTD 110, where a may be a horizontal angle of incidence. (A vertical angle of incidence λ is not illustrated.) β represents the angle between the VTD backplane 320 and the wall 330 of the arena 100. γ is determined from α and β. For example, in the configuration illustrated,
γ=180°−(α+β).

In the embodiment illustrated in FIG. 3, two VTDs 110a and 110b have captured rays of light 310a and 310b, respectively, from the TPS 120, and corresponding incidence angles γ1 and γ2 may be calculated for the two VTDs. The two VTDs 110a and 110b share a common wall 330, with a known length Len. Based on this, a length representing the orthogonal distance from wall 330 to TPS 120 may be calculated as:
Len3 =tan(γ2)*Len/tan(γ1)

Further, from the arena 100 geometry depicted, it is evident that a second length, Len 2, measured from the corner of the arena containing VTD 110b to the point of intersection of the perpendicular connector between TPS 120 with wall 330 can also be determined as:
Len2=Len3/tan(γ2)

With Len3 and Len2 determined, the location of TPS 120 in two dimensions, relative to the walls of the arena 100, has now been determined.

Persons skilled in the relevant art(s) will appreciate that while the foregoing calculation has only determined the location of the TPS 120 in two dimensions, the location of the TPS 120 in three dimensions can be readily determined via analogous calculations, provided additional data is present. The additional data may be an additional pair of angles for each VTD 110, wherein one angle in the pair indicates an angle of orientation between the backplane of the VTD 110 and an arena 100 ceiling or floor (not shown), while a second angle λ (not shown) represents the vertical angle of incidence of the light 310 from the TPS 120 on the backplane 320 of the VTD 120.

Persons skilled in the relevant art(s) will also appreciate that other configurations or layouts of the area 100 space and the VTDs 110 may require variations on the formulas shown, but that in all cases it is possible to calculate the location of a TPS 120 provided the necessary information of angular incidence of light on the backplane is captured from a VTD or VTDs 110.

FIG. 4A and FIG. 4B together illustrate an approach 400 for locating a TPS 120 in a VTD 110 field of view, and hence for identifying an angle α, where α represents the angle of incidence of a ray of light 310 from a TPS 120 relative to the backplane 320 of a VTD 110 (as discussed in conjunction with FIG. 3, above).

FIG. 4A illustrates a VTD 110 observing two TPSs 120, with rays of light 310 from the TPSs 120 striking a lens or other optical element (not shown) of the VTD 110. The lens or other optical elements, possibly in combination with other optical elements (not shown) focuses the rays of light 310 from the TPSs 120 onto backplane 320 (i.e., the imaging element) of VTD 110. The backplane 320 is here represented as a matrix of discrete pixel elements 410 (i.e., sensor cells), which may be physical pixel elements, or which may be logical pixel elements derived from a scanning process or similar process which extracts image information from a continuous light sensitive media of backplane 320. Together, discrete pixel elements 410 comprise a digitized field of view of the TPSs 120 within the field of view of VTD 110. Each TPS 120 light source may be perceived by the VTD 110 as a heightened area of sensed light intensity in a bounded area 420 of the digitized field of view.

FIG. 4B illustrates how different pixel elements or sensor cells 410 in the bounded area of detection 420 may detect different degrees of light intensity. In the figure, the light intensity is exemplified by the height of a pixel element 410. (The “height” is representational only, corresponding to a recorded light intensity, and does not correspond to a physical, structural height of a pixel in a physical backplane or imaging element.) Pixel element 410 may only be considered to have detected light from a TPS 120 if the measure of light intensity from the pixel element 410 exceeds a threshold value.

The pixel elements or sensor cells 410 used to compute a centroid are separated by their amplitude, grouping, and group dimensions. The center of a TPS 120 image on the backplane 320 is located by finding the optical centroid (X_{c}, Y_{c}) of the TPS 120 light source, using the equations:
X_{C}=(ΣI_{XY} * X_{XY})/ΣI_{xy}
Y_{C}=(ΣI_{XY} * Y_{XY})/ΣI_{xy}

where I_{XY} is the measured light intensity of a pixel element 410 within the area of detection 420, X_{XY} is the X-coordinate of the pixel element 410 relative to the area of detection 420, and Y_{XY} is the Y-coordinate of the pixel element 410 relative to the area of detection 420.

Corrections may be applied to the computation of this centroid. The first of these corrections is a temperature based offset of intensity amplitude on a per cell basis. The second compensation is the exact X:Y location of each cell based on corrections for errors in the optics inherent in VTD 110. These corrections are applied locally prior to the centroid computation being made for each TPS centroid.

Once a determination has been made of the XY-position of the centroid, the offset angles from the center of the VTD field of view at which rays of light from the TPS impinge on the TPS backplane 320 can be readily determined using calculations which are well-known in the art. So, for example, the angle α illustrated in FIG. 3, which represents an angle of incidence of a ray of light 310 from a TPS 120 relative to the backplane 320, may be calculated according to the method described here.

In one embodiment of the present invention, the calculations described above may be performed by VTD 110. In another embodiment of the present invention the calculations may be performed by DAE 140.

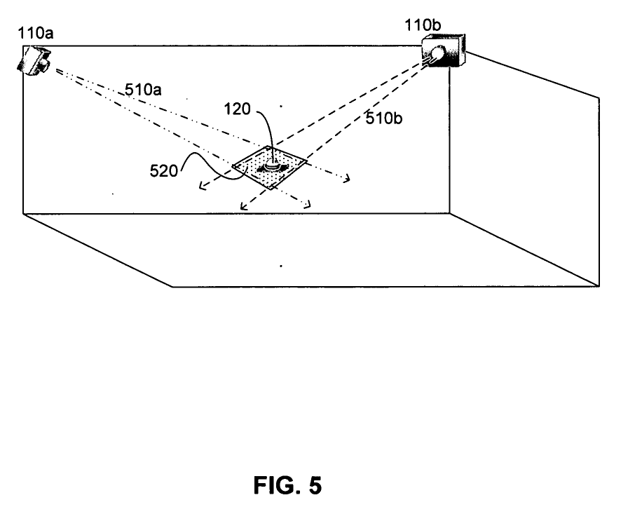

In an embodiment of the present invention, it may not be possible for a VTD 110 to determine perfectly precise angles for the location of the TPS 110 centroid, but rather a range of angles which determine a spatial cone in which a TPS be considered to be contained with a high degree of probability. FIG. 5 illustrates a single TPS 120 which is within the field of view of two VTDs 100a and 100b. Pairs of lines 510a and 510b extending from each VTD 110a and 110b respectively indicate an angular range within which each VTD 110 has determined a high probability that the TPS 120 may be found. The intersection of pairs of lines 510a and 510b determines a substantially localized region 520 within which there is a high probability that the TPS 120 may be found.

For simplicity of viewing only two lines 510 are shown extending from each VTD 110, implying a planar location determination 520; persons skilled in the relevant arts will appreciate that a full determination will involve a cone of high probability extending from each VTD 110, with a corresponding, substantially localized volume of high probability of TPS 120 location determined by the intersection of the cones. If the TPS 110 is in the field of view of more than two VTDs 110, the intersection of more than two cones of probability may result in an improved location determination for the TPS 110.

In an embodiment of the present invention, in addition to determining the location of the TPS centroid, and from there an angle of incidence of the light from the TPS 120, the method of the present invention may also record a light intensity of the centroid, such as a maximum intensity or an average intensity, or other intensity data. This intensity data may be used as a means to perform an estimation of the distance of a TPS 120 from a VTD 110, wherein a greater light intensity may correspond to a closer distance between TPS 120 and VTD 110, and a lesser light intensity may correspond to a greater distance between TPS 120 and VTD 110. This estimation of distance may be used to check, confirm, or otherwise correlate with or supplement TPS 120 location determinations which are made via other methods of the present invention.

TPS Identification

As described above in conjunction with FIG. 3, in order for a determination to be made of the location of the TPS 120, the TPS 120 may need to be “seen” or identified in the same perception frame by at least two VTDs 110. In turn, this may require that the TPS 120 image which is seen by a VTD 110 can be identified as being associated with a particular TPS 120, so that two VTDs 110 may both report that they have location-related data for the same TPS 120. Put another way, a key to matching a TPS 120 viewed by different VTD 110s may be the ability to uniquely identify a TPS 120 in the field of view of each VTD 110.

In an embodiment of the present invention, a VTD 120 is identified by its energy emission pattern, i.e., by the way it modulates its light emission on and off. Since the energy may be modulated on a per-perception frame basis, it may be necessary for a VTD 110, or for a DAE 140 which processes VTD data, to identify a TPS 110 which has moved in space, and has therefore moved in the VTD 110 field of view, from one perception frame to the next. In turn, to identify a TPS 120 from one perception frame to the next may require that a VTD 110 or DAE 140 be able to anticipate an approximate expected location for a TPS 120 which has already been seen.

The method of the present invention computes an equation of motion for each TPS 120 based on a recent past history of movement by the TPS 120, where the recent past history may comprise TPS 120 location from two or more perception frames, several seconds of successive perception frames, several minutes of successive perception frames, or a longer series of perceptions frames. Because TPS 120 energy emissions are modulated on and off, the equations of motion may be derived based on location-related data from perception frames which are not necessarily consecutive, i.e., where there are gaps in the perception frames. Equations of motion may include both path equations, which may take the form of algebraic equations which delineate a path in three-dimensional space, and equations for TPS 120 velocity and acceleration, which may be first and second order differential equations.

By computing equations of motion at each VTD 110, it may be possible to enable a substantially continuous tracking of a VTD 110. In turn, this substantially continuous tracking may make it possible to detect when a VTD 110 modulates its light emission. This modulation is decoded as a serial message which includes the identification of the TPS 120. (The details of TPS modulation are discussed further below.)

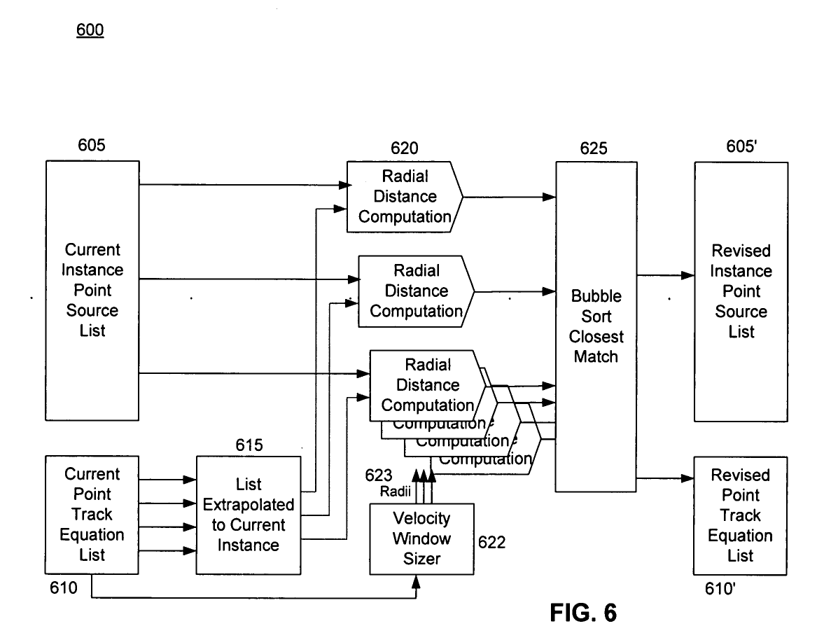

Once a TPS 120 centroid is established for more than one frame period, a process of identifying the TPS 120 is begun. To this end a radial bubble sort process 600 is employed to re-identify the TPS 120 on each successive perception frame. FIG. 6 illustrates both the basic components and the steps in this process.

DAE 140 maintains a TPS list 605 of each currently known TPS 110, i.e., each TPS 110 which has been previously identified. DAE 140 also maintains a list 610 of a previously calculated equation of motion for each TPS 120 in list 605.

For each perception frame, motion equations 610 for each known TPS 120 may be advanced to the current time, resulting in a list of extrapolated TPS positions 615. The predicted (i.e., extrapolated) positions of the known TPSs 120 may then be compared to detected TPS 120 positions via a radial distance computation 620. Allowed distances, i.e., allowed radii 622 for the radial distance computation 620 may vary on a per-TPS basis, and may be determined via a velocity-based window sizer 622, which determines allowed radii depending on the predicted velocity of the known TPSs. (This is discussed further below.)

These distances, i.e., the distances between extrapolated positions of known TPSs and currently detected TPSs, are then sorted using a radial closest match algorithm 625 to yield a best fit between predicted TPS 120 positions and observed TPS 120 positions. The sorting algorithm employed may be a bubble sort, or some other sorting algorithm may be used. When a radial match occurs, meaning a currently detected TPS has been determined to be the same as a previously identified TPS, the TPS history 605′ and equations 610′ are updated for the next frame.

In an embodiment of the present invention, a maximum allowed radius is established, wherein this maximum allowed radius determines a maximum distance that a TPS may be expected to move from one perception frame to the next. This maximum allowed radius may be based on a number of factors including, for example and without limitation, a user-defined or pre-programmed absolute maximum radius for an entire simulation run or part of a simulation run; a maximum radius for a TPS based on the previously calculated velocity or equation of motion of the TPS, wherein this maximum allowed radius may be varied over time as it is determined that the equation of motion changes; or a maximum allowed radius for the type of entity to which the TPS is attached. For example, the maximum allowed radius for a TPS attached to a powered vehicle may be greater than the maximum allowed radius for a TPS attached to a person whose means of locomotion is limited to walking or running.

If a TPS 120 centroid falls out of the maximum allowed radius, then it is assumed to be a new TPS 120 and a new set of equations are started. When a TPS 120 is not detected on a given frame, the equations are coasted and the TPS 120 entry may be marked as modulated. (TPS modulation is discussed further below.) “Coasting” of a TPS means that a future position of the TPS is extrapolated based on a known (i.e., measured) past position and based on the previously determined equation of motion for the TPS 120. TPS 120 equations may be coasted for a certain number of frames, then deleted as a valid entry if there is no subsequent re-identification. In one embodiment of the present invention, the threshold number of frames beyond which a TPS 120 may be considered invalid if not re-identified is a fixed, set number of frames for all TPSs 120 within the simulation.

In an alternative embodiment, the threshold number of frames for TPS 120 invalidation may be varied depending on a number of factors including, for example and without limitation, a velocity of a TPS 120, an acceleration of a TPS 120, a global spatial density of TPSs 120 within the arena environment, a local TPS 120 spatial density in the vicinity of the TPS 120, or a determined accuracy rate or error rate of TPS 120 re-identification.

In an embodiment of the present invention, two or more distinct, currently detected TPSs 120 may be determined to both possibly be a previously identified TPS 120, or two or more distinct previously identified TPSs 120 may both be determined to possibly be a currently identified TPS 120. A range of strategies may be employed to respond to these ambiguous cases including, for example and without limitation:

withholding any assignment of a newly identified TPS 120 to a previously identified TPS 120 until additional data has been gathered in one or more following perception frames;

making a tentative or provisional assignment between a newly identified TPS 120 and a previously identified TPS 120, but reevaluating the assignment based on additional data gathered in following perception frames;

retaining current frame analysis data for use in later reevaluation;

providing notifications to users and/or simulation operators of the possibility of an incorrect TPS 120 identification;

providing to TPS 120 users and/or simulation operators an opportunity for human intervention to validate and/or correct a known-TPS/newly-identified-TPS assignment (wherein the human intervention may entail pausing the simulation; or may entail allowing the simulation to continue in a full mode or a limited mode of operation, even while ambiguous data is being subject to human validation or correction).

TPS Modulation

Each TPS 120 uniquely identifies itself to the system via a unique modulation pattern of its light or energy emission. TPSs 120 may use a synchronous message in the identification process, which is decoded by the DAE 140 as part of the tracking processing. TPSs 120 may use an isochronous message in the identification process which is decoded by the DAE 140 as part of the tracking processing. Alternatively, this decoding may be done at the VTD 110s. Both the synchronous modulation process and the isochronous modulation process are discussed further below.

In an embodiment of the present invention, TPSs 120 may also use emissions of light energy at varied frequencies (for example, at varied frequencies within the infrared range) as an alternate or additional means of signaling TPS 120 identity, TPS 120 orientation, or other pertinent TPS 120 data.

Synchronous TPS Modulation

In an embodiment of the present invention, the synchronous modulation scheme may be enabled in part by a means to ensure that the perception frames of all VTDs 110 in the arena 100 are substantially synchronized in time. For example, all the VTDs 110 may be connected to a local area network (a LAN) which synchronizes the perception frames of all VTDs 110, or a single master VTD 110 may send a synchronization signal to all the other VTDS 110 in the arena. Other methods and means to substantially synchronize the perception frames of the VTDs 110 may be employed as well.

The synchronous modulation scheme may be further enabled by means of an enhanced TPS 120. An enhanced TPS 120 may contain a means for receiving a signal, wherein the signal may be, for example and without limitation, a radio frequency signal (i.e., a wireless signal), an infrared signal (which may be at a different infrared frequency than the infrared frequency emitted by the TPS 120), a magnetic signal, a laser signal, an electromagnetic signal, or an audio signal.

The synchronous modulation scheme may further comprise synchronizing the energy emissions (for example, the infrared light emissions) of the TPSs 120 with the perception frames of the VTDs 100 by means a synchronization signal, wherein the synchronization signal may employ one of the transmission means or media described immediately above (e.g., a wireless signal, a laser signal, an infrared signal, an audio signal, etc.).

The synchronization signal may take the form of a brief pulse of energy which signals the enhanced TPSs 120 that a perception frame has begun, wherein each enhanced TPS 120 may then transmit a bit in its modulation scheme, wherein each transmitted bit is substantially synchronized with the beginning of the VTD perception frames. The synchronization signal may be emitted by a master VTD 110, or may be emitted by some other master device, such as a network server (which may be the DAE 140) which also synchronizes the VTDs 110. Other sources of synchronization are possible as well.

Within the time span (i.e., the duration) of a perception frame, a VTD 110 may have an interval of maximum light perception, wherein the interval of maximum light perception is shorter than the overall duration of the perception frame. In an embodiment of the invention, a TPS 120 which is synchronized to the VTD 110 sampling period may allow shortened light emissions from the TPS 110; that is, the TPS 120 may only emit energy during part of the energy emission event 703, and preferably during an interval which coincides with or at least partially overlaps with the peak sensitivity of the VTD array's sensors 110. This may result in reduced power consumption and a longer time of operational use of a TPS 110 before the TPS 110 power source (e.g., a battery) needs to be replaced or recharged.

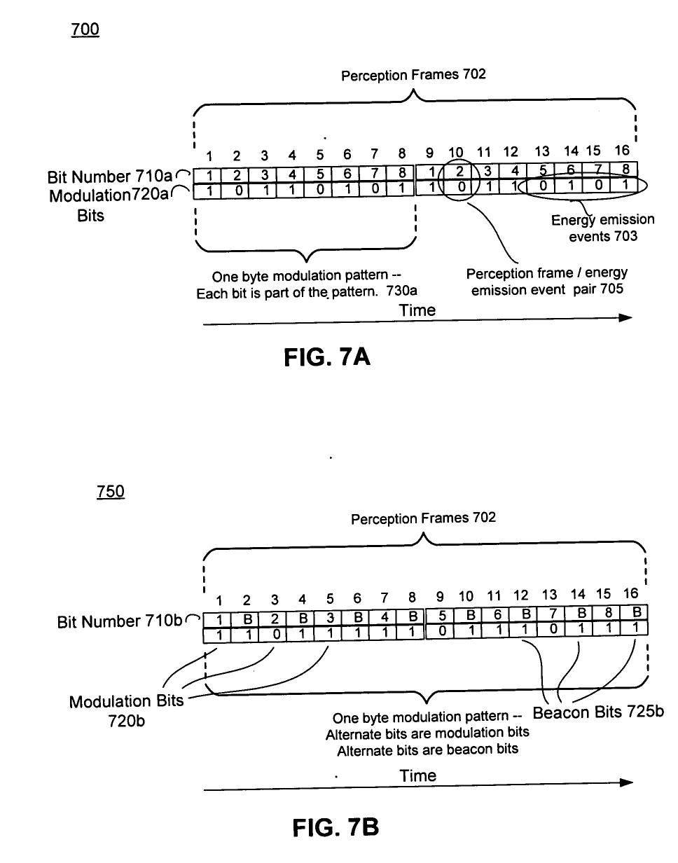

FIG. 7A illustrates the synchronous modulation scheme 700 according to one embodiment of the present invention. Periods of time where the TPSs 110 emit light energy are referred to as energy emission events 703. All energy emission events 703 are substantially synchronized with perception frames 702, wherein there exist pairings 705 of perception frames 702 and energy emission events 703. Because the timings of the energy emission events 703 and perception frames 702 are substantially synchronized, each energy emission event 703 may be used to convey a single bit of modulation pattern data, with substantially minimal risk that the VTDs 110 may miss a modulation pattern bit.

In exemplary modulation scheme 700 there may be 16 perception frames per second. In a simulation which uses two hundred and fifty-five (255) or fewer TPSs 120, an 8-bit modulation scheme 730a may be used to uniquely identify each TPS 120. (While 8-bits allow for two hundred and fifty-six (256) modulation patterns, one of those patterns would be all zeros, meaning the TPS 120 assigned that modulation pattern would never transmit any signal, and hence would not be identified or tracked. This means that an 8-bit scheme may only allow for two hundred and fifty-five TPSs 120.) Hence, a TPS 120 may transmit its entire 8-bit modulation scheme 730a in eight energy emission events 703, where each energy emission event 703 from the TPS 120 is used to convey one bit 720a of the TPSs 110 unique modulation pattern 730a. FIG. 7A illustrates how there is one modulation bit 720a corresponding to each sequential bit number 710a. As a result, the TPS 120 may identify itself to the VTDs 110 twice per second.

In synchronous modulation scheme 700, some unique modulation patterns may have a high ratio of off-emissions (no light is emitted by TPS 120) as compared to on-emissions (light is emitted by TPS 120). Examples of such modulation patterns may be “00000001”, “00000010”, etc. Put another way, some unique modulation patterns may have a low duty cycle of energy emission. As a result, both the VTDs 110 and the algorithms and methods 200, 300, 400, 500 and 600 to track TPS 120 location may have insufficient data to reliably and consistently track some TPSs 120.

FIG. 7B illustrates a method for synchronous modulation 750 according to an alternative embodiment of the present invention wherein all TPSs may maintain a higher duty cycle, which may result in improved tracking and identification reliability. In this method 750, a subset of perception frames 702 may be associated with modulation bits, wherein the TPS 120 modulates its energy emissions according to a unique modulation pattern, represented by modulation bits 720b; while the remaining perception frames 702 may be associated with beacon bits 725b, which are marked in FIG. 7B with the letter ‘B’, wherein for each energy emission event corresponding to a beacon bit 725b the TPS 120 always emits energy, i.e., the TPS 120 is always modulated on.

In the exemplary embodiment shown in FIG. 7B, energy emission events 703 corresponding to odd-numbered perception frames 702 are used to convey modulation pattern data, and so may be modulated on or off; while energy emission events 703 corresponding to even-numbered perception frames 702 always correspond to beacon bits B, and so are always modulated on (i.e., light is always emitted). As a result of synchronous modulation scheme 750, the overall duty cycle exhibited by the TPS 120 may be higher than may be the case with synchronous modulation scheme 700, which may result in improved TPS 120 tracking reliability.

Persons skilled in the relevant arts will appreciate that the synchronous modulation schemes 700 and 750 described above are exemplary only, and that variations on these synchronous modulation schemes may be employed within the overall scope of the present invention. In an embodiment of the invention, a TPS 120 using a synchronous modulation scheme may modulate its emitter with a message no less frequently than every other perception frame period.

In an alternative embodiment of the present invention, the TPSs 110 may be further enhanced to not only received a synchronization signal, but to transmit additional data via the same link used for the synchronization signal or via another link. For example, by means of a wireless link each enhanced TPS 120 may communicate its orientation and rotation relative to an initial vector established during initialization of the simulation.

In an alternative embodiment of the present invention, the enhanced TPS 120 may receive a message to modulate its infrared emitter on or off as an alternate scheme to identify the TPS 120.

Isochronous TPS Modulation

As noted above, a synchronous modulation scheme may be employed to synchronize the timing the of each TPS 120 energy emission event with the VTD 110 perception frames. However, such a scheme may involved greater complexity for each TPS 120, which may also result in greater system cost. A modulation scheme which may result in reduced system complexity and may result in reduced system cost is an isochronous modulation scheme, which may also be known as a moving window transmission scheme.

A TPS 120 may implement isochronous messaging to adapt to reception by a VTD 110 array where no synchronization is inherent between the VTD array 110 and the TPSs 120. (The VTDs 110 in the VTD array, however, may still have their perception frames synchronized with each other.) In an embodiment of the invention each TPS 120 may have a duration of an energy emission event, wherein the duration of the energy emission event may be fractionally longer or fractionally shorter than the duration of a perception frame. In turn, this means that each successive energy emission event from a TPS 110 will “slip”, or shift its start time, by a fractional part of the duration of a perception frame.

In an exemplary embodiment of the present invention, a VTD 110 perception frame may be 1/16^{th} of a second in duration. In turn, an energy emission event from a TPS 120 may have a duration which is substantially close to 15/16^{ths} of that duration, or in other words, to 15/16^{ths} of 1/16^{th} of a second, i.e., 15/256^{ths} of a second. As a result,on each successive energy emission event the TPS 120 slips the start time by 1/16^{th} of a the duration of a perception frame (that is, by approximately 6%) on each successive perception frame period.

For example, on some particular perception frame, the TPS 120 may begin an energy emission event precisely at or substantially at the beginning of the VTD 110 perception frame. The TPS 120 may then begin its next consecutive energy emission event 1/16^{th} of a frame interval before the end of the first perception frame interval, and therefore 1/16^{th} of a frame interval before the start of the next consecutive perception frame.

In this isochronous modulation scheme, over an extended period of time (which may span several seconds or longer), there may be intervals of time (which may span a plurality of perception frames) where the TPS 120 energy emission events may be substantially synchronized with the VTD 110 perception frames; and there may also be intervals of times (which may span a plurality of perception frames) where the TPS 120 energy emission events may be substantially not synchronized with the VTD 110 perception frames. In an embodiment of the present invention, it may also be the case that when a TPS 120 is modulated on, either to convey an on-bit in a modulation pattern or to convey a beacon bit, the TPS 120 may nonetheless emit light only during a portion or a fraction of the time interval of the energy emission event.

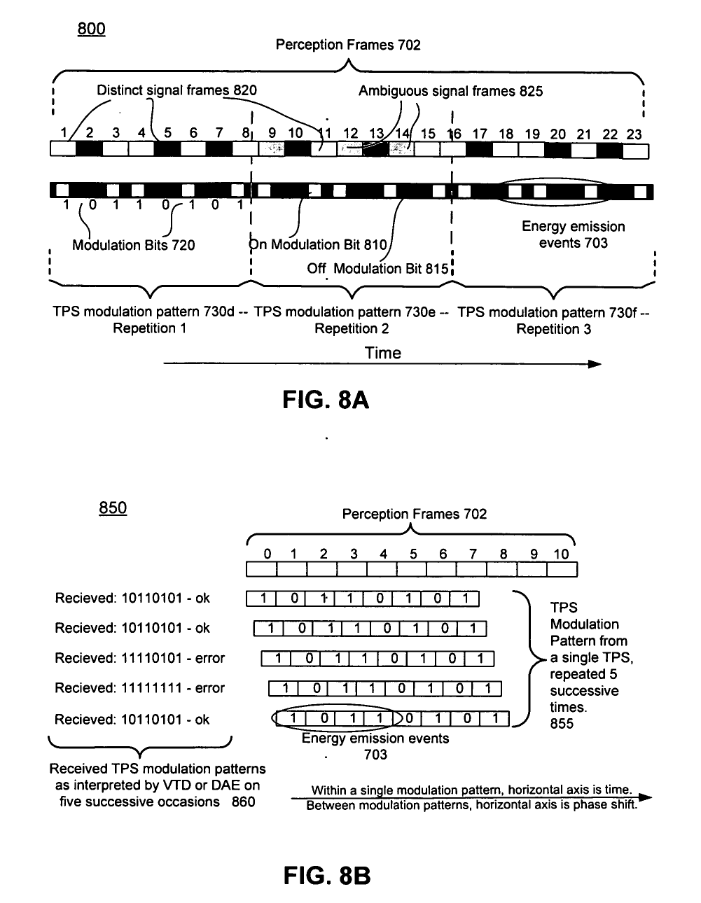

FIG. 8A shows how an exemplary isochronous modulation scheme 800 permits a VTD 110 to determine the modulation pattern of a TPS 120. Note that in this figure, as well as in FIG. 8B discussed below, energy emission events 703, modulation bits 720, and modulation pattern 730 are numbered analogously to the same elements in FIG. 7A and FIG. 7B. This reflects the possibility that, apart from timing and/or synchronization differences, the TPS 120 modulation scheme and TPS 120 energy emission events may be similar or substantially the same for both the synchronous modulation scheme and the isochronous modulation scheme.

Put another way, the synchronous modulation scheme and the isochronous modulation scheme may both share a method wherein TPSs 120 are identified by a unique bit pattern (the modulation pattern 730 comprised of modulation bits 720), wherein each bit is signaled by an energy emission event 703. The differences between the two modulation schemes, synchronous vs. isochronous, may then be categorized, in whole or in part, by: (i) a consistent synchronization or lack of consistent synchronization, respectively, between the TPS 120 energy emission events 703 and the VTD 110 perceptions frames 702; and (ii) the means and method by which a VTD 110 or DAE 140 demodulates the TPS 120 modulation pattern 730.

FIG. 8A illustrates a TPS modulation pattern 730 comprised of energy emission events 703, where each energy emission event 703 represents a modulation bit 720. There are off modulation bits 810 and on modulation bits 815, wherein during an on modulation bit 815 the TPS 120 may only emit energy during part of the energy emission event 703. TPS modulation pattern 730d repeats over time as TPS modulation pattern 730e and TPS modulation pattern 730f.

During repetition one (1) of the TPS modulation pattern 730d, the TPS 110 energy emission events 703 may be substantially synchronized in time with perception frames 702. As a result, during each perception frame 702, VTD 110 may obtain a substantially unambiguous energy reading indicating that the TPS 120 either is emitting energy or is not emitting energy. This results in perception frames 702 which receive a clear signal, referred to as distinct signal frames 820; these are represented in the figure by frame blocks filled with either black or white, which in turn represent a substantially unambiguous on-bit (1 value) or off-bit (0 value). This results in a correct reading by the VTD 110 of the TPS modulation pattern 730d.

During repetition two (2) of TPS modulation pattern 730e, some or all of the TPS 110 energy emission events 703 may be substantially not synchronized in time with perception frames 702. As a result, some perception frames 702 still yield distinct signal frames 820 (though some of these may in fact be erroneous), while other perception frames 702 yield ambiguous signal frames 825, represented in the figure by frame blocks filled with shades of gray. These ambiguous signal frames 825 represent perception frames 702 where little much light was received by the VTD 110 to be unambiguously interpreted as an on-bit (1 value), and at the same time too much light was received to be unambiguously interpreted as an off-bit (0 value).

During repetition three (3) of TPS modulation pattern 730f, the TPS 110 energy emission events 703 may again be substantially synchronized in time with perception frames 702, which again results in a correct reading by the VTD 110 of the TPS modulation pattern 730f.

When a VTD 110, or a DAE 140 which receives a signal from a VTD 110, determines that ambiguous signal frames 825 are present over a period of time which may comprise one or a plurality of perception frames, a determination may be made by the method of the present invention that it is not possible to obtain a reliable modulation pattern 730 determination for the TPS 120. This may also be stated as saying that VTD 110 determines that it has received an ambiguous modulation pattern from TPS 120. In that event, the TPS 120 may still be identified by associating it with an extrapolated position of a known TPS 120, as per the methods described above.

When a VTD 110, or a DAE 140 which receives a signal from a VTD 110, determines that consecutive distinct signal frames 825 are present over a period of time which may comprise at least the number of perception frames required to detect a modulation pattern 730, a determination may be made by the method of the present invention that it is possible to obtain a reliable modulation pattern 730 determination for the TPS 120. This may also be stated as saying that VTD 110 has received an unambiguous modulation pattern from TPS 120, where this determination may be made by VTD 110 or by DAE 140. In this event, TPS 120 may be identified from its modulation pattern 730.

FIG. 8B illustrates the method of an exemplary isochronous modulation scheme 850 according to another embodiment of the present invention. In this embodiment the VTD 110 may never report an ambiguous signal frame 825, but may instead always report a distinct signal frame 820. However, over time the energy emission events 703 still shift in phase relative to the perception frames 702, as seem from the five phase-shifted TPS modulation patterns 855, which represent successive emissions of the same modulation pattern from a single TPS. As a result, at times energy emission events 703 may be substantially in phase with perception frames 702, during which intervals the VTDs 110 may correctly demodulate the modulation pattern 730. At other times energy emission events 703 may be substantially out of phase with perception frames 702, during which intervals two adjacent energy emission events 703 may both overlap with a single perception frame 702, which may result in an incorrect reading during the perception frame.

The result is that the received modulation pattern signal 860, i.e., the modulation pattern which is received at the VTD 110 (as opposed to the modulation pattern transmitted by the TPS 120), will be correct sometimes and incorrect other times. When the TPS modulation pattern 730 is received correctly by VTD 110, then the TPS 120 can be identified by that unique modulation pattern 730. These patterns are flagged as “ok” in FIG. 8B. When the TPS modulation pattern 730 is received incorrectly by VTD 110, the incorrect modulation pattern may vary due to variations in the phase differential between perception frames 702 and energy emission events 703, as shown with the two different TPS modulation patterns 730 flagged as errors among received modulation pattern signals 860.

Even though, with the isochronous modulation scheme 850 of FIG. 8B, there may be intervals when an erroneous TPS modulation pattern 730 is detected, the DAE 140 and/or VTD 110 may maintain continuous track on a TPS 120. This may be done by recognizing that TPS modulation patterns 730 which are detected may be inconsistent with a previously detected TPS modulation pattern or patterns 730, and may further vary randomly, and therefore do not indicate a new TPS; while TPS modulation patterns 730 which are consistent (i.e., identical) may represent the same TPS 120. Continuous tracking of the TPS 120 via the present method may be further assisted using calculations to extrapolate TPS 120 position, and to associate a newly identified TPS 120 with a previously identified TPS 120 using the closest-match algorithms discussed in conjunction with FIG. 6 above.

Persons skilled in the relevant arts will appreciate that the isochronous modulation schemes 800 and 850 described above are exemplary only, and that variations on these isochronous modulation schemes may be employed within the overall scope of the present invention.

In an embodiment of the present invention, a TPS 120 using an isochronous modulation scheme may use a subset of energy emission events 703 for beacon events, wherein energy is always emitted during said subset of energy emission events 703; beacon events may be used to increase the overall duty cycle, which may increase tracking reliability. The remaining subset of energy emission events 703 may then be used by TPS 110 for the modulation pattern 730. In an embodiment of the invention, a TPS 120 may modulate its emitter with a message no less frequently than every other energy emission event.

In an embodiment of the present invention, a TPS 120 may use different durations of time for energy emission events which are modulated on and energy emission events which are modulated off. A TPS 120 may also introduce additional shifts and variations into the transmission of the modulation pattern. In an embodiment of the present invention, if a sent bit field indicates that no emission is to be made, then the energy emission event may be begun 6% sooner and extended 6% later. In alternative embodiments, different amounts of extension may be used. Once a full modulation pattern has been sent, the presumed perception frame start time may be shifted by a fixed percent and the transmission may be restarted.

In an embodiment of the present invention, a VTD 110 may modify the duration in time of its perception frame in response to the perceived signal from the TPS 120.

Combined Elements

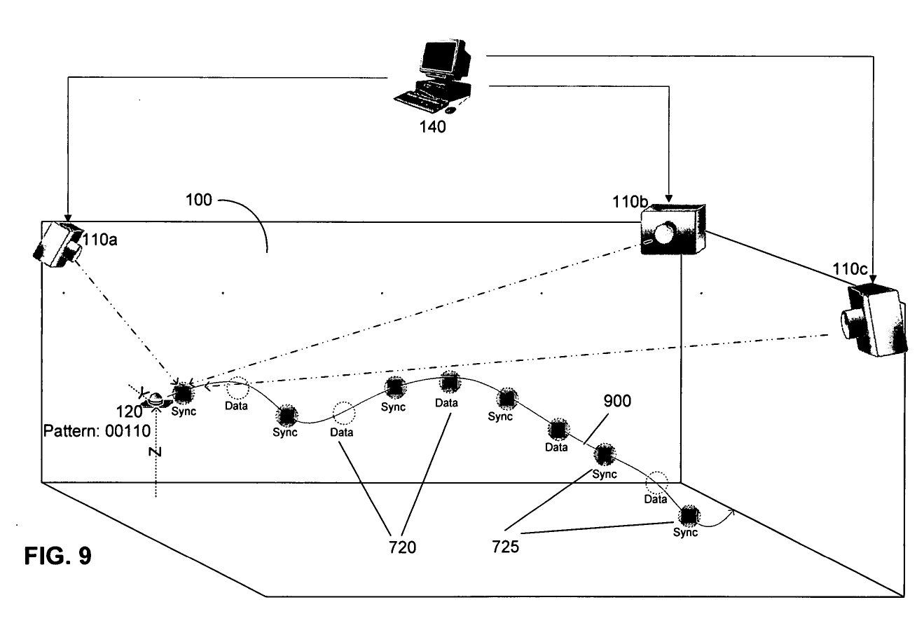

FIG. 9 illustrates various aspects of the present invention, as discussed above, working in combination according to one possible embodiment of the invention. A TPS 120 is being modulated as it moves through the arena 100 space, as illustrated by the alternating data bits 720, which are synonymous with the modulation bits 720 discussed above; and the alternating sync bits 725, which are synonymous with the beacon bits discussed above. (Note the sync bits 725 are always modulated on, i.e., the TPS emits light, while data bits 720 may be modulated on or off.)

DAE 140 receives two-dimensional angular information from multiple VTDs 110, which includes identity information (i.e., TPS 120 modulation data, wherein in the case illustrated the unique TPS modulation pattern 730 is ‘00110’). DAE 140 uses computed 3-dimensional fixes from various pairs of VTDs 110 to arrive at a bounding space which encloses the actual position of TPS 120. A curve is fit to the centroid of each of these bounded spaces and is assumed to be the current path 900 of TPS 120. The DAE 140 builds motion formulas and exports motion equation coefficients for each TPS path 900 on a frame by frame basis.

Summary

While some embodiments of the present invention have been described above, it should be understood that it has been presented by way of examples only and not meant to limit the invention. It will be understood by those skilled in the art that various changes in form and detail may be made therein without departing from the spirit and scope of the invention as defined in the appended claims. Thus, the breadth and scope of the present invention should not be limited by the above-described exemplary embodiments, but should be defined only in accordance with the following claims and their equivalents.

What is claimed is:

1. A method for identifying the location of an entity in a three-dimensional space comprising:
(a) modulating an energy emission from a source of energy emission, wherein the source of energy emission is attached to the entity, and wherein the energy emission from the source is modulated according to an energy modulation pattern;
(b) monitoring the source using an energy detection device;
(c) obtaining from the energy detection device at least one of the energy modulation pattern of the source or an identification of the source determined by the energy detection device based on the energy modulation pattern;
(d) obtaining from the energy detection device location-related data for the source; and
(e) analyzing the location-related data to determine the location of the source.

2. The method of claim 1, wherein the source modulates its energy emission according to an energy modulation pattern unique to the source.

3. The method of claim 1, wherein the energy emission from the source is an infrared (IR) energy emission.

4. The method of claim 1, wherein the energy detection device detects energy from the source during each of a series of perception frames that occur at a periodic perception frame rate.

5. The method of claim 4, further comprising determining an angular movement of the entity by determining over a plurality of perception frames the locations of a plurality of sources of energy emission which are attached to the entity.

6. The method of claim 4, further comprising modulating the energy from the source according to a synchronous modulation scheme, said synchronous modulation scheme comprising:
(i) synchronizing the energy emission of the source with the perception frame of the energy detection device;
wherein a single period of time wherein energy may be emitted or energy may not be emitted from the source to signal a single bit in the energy emission pattern is an energy emission event; and
wherein the duration in time of an energy emission event is substantially the same as the duration in time of a perception frame;
(ii) modulating the energy emission from the source on or off during a single energy emission event;
wherein the source is modulated on by at least one of emitting energy for greater than an on-modulation threshold period of time during the energy emission event or emitting energy at greater than an on-modulation threshold level of energy during the energy emission event; and
wherein the source is modulated off by at least one of emitting energy for less than an off-modulation threshold period of time throughout the duration of the energy emission event or emitting energy at less than an off-modulation threshold level of energy throughout the duration of the energy emission event;
(iii) modulating the energy emission from the source on or off over a plurality of energy emission events;
wherein the number of energy emission events in the plurality of energy emission events equals a number of bits in the energy modulation pattern; and
wherein the modulated energy emission over the plurality of energy emission events conforms to the energy modulation pattern.

7. The method of claim 6, wherein step (i) further comprises synchronizing the energy emission of the source with the perception frame of the energy detection device by a synchronization signal, wherein the synchronization signal comprises at least one of an infrared signal, a magnetic signal, a radio frequency signal, a laser signal, an electromagnetic signal, or an audio signal.

8. The method of claim 6, further comprising:
(iv) selecting a first subset of the energy emission events as beacon events,
wherein the unique source is always modulated on during a beacon event;
(v) selecting the energy emission events which are not part of the first subset as a second subset of signal-modulation events; and
(vi) modulating the energy emission from the unique source according to the modulation pattern over a plurality of signal-modulation events.

9. The method of claim 4, further comprising modulating the energy from the source according to an isochronous modulation scheme, said isochronous modulation scheme comprising:
(i) establishing a fixed periodic rate of energy emission activity for the unique source, wherein the fixed periodic rate of energy emission activity is substantially close to the perception frame rate but is not the same as the perception frame rate;
wherein each period of energy emission activity from the unique source is an energy emission event, wherein each energy emission event persists for a period of time which is substantially close to but not that same as the duration in time of the perception frame; and
wherein an energy emission event may be substantially in phase with a perception frame, and wherein another energy emission event may be substantially out of phase with an immediately preceding perception frame and a perception frame which immediately follows the immediately preceding perception frame;
(ii) modulating a consecutive series of energy emission events of the unique source on or off over a plurality of energy emissions events;
wherein the source is modulated on by at least one of emitting energy for greater than an on-modulation threshold period of time during an energy emission event or emitting energy at greater than an on-modulation threshold level of energy during an energy emission event;
wherein the source is modulated off by at least one of emitting energy for less than an off-modulation threshold period of time throughout the duration of an energy emission event or emitting energy at less than an off-modulation threshold level of energy throughout the duration of an energy emission event;
wherein the number of energy emission events in the plurality of energy emission events equals a number of bits in the energy emission pattern; and
wherein the modulated energy emission over the plurality of energy emission events conforms to the energy modulation pattern; and
(iii) determining when a received modulated energy emission from the source which is received by the energy detection device conforms to the energy modulation pattern of the source.

10. The method of claim 9, wherein step (iii) comprises at least one of determining that the energy modulation pattern detected from the source of energy modulation conforms to a previously detected energy modulation pattern of the source or determining that the energy modulation pattern received from the source of energy modulation is an unambiguous energy modulation pattern.

11. The method of claim 4, further comprising determining at least one of a path of movement of the source or an equation of motion of the source based on the location of the source during a plurality of perception frames.

12. The method of claim 11, further comprising extrapolating an extrapolated current position of the source based on at least one of a past location of the source, the path of movement of the source, or the equation of motion of the source.

13. The method of claim 12, further comprising determining that a newly identified source is the same as a previously identified source based on the location of the newly identified source and the extrapolated current position of the source.

14. The method of claim 13, further comprising distinguishing a plurality of newly identified sources of energy emission by using a closest match algorithm to determine which newly identified source is associated with the extrapolated current position of the source.

15. The method of claim 1, wherein the location-related data comprises at least one of an angular displacement or an energy intensity for the source detected by the energy detection device.

16. The method of claim 1, further comprising monitoring the source using a plurality of energy detection devices.

17. The method of claim 16, wherein each energy detection device detects energy from the source within a field of view of the energy detection device, and wherein at least two of the energy detection devices have an overlapping field of view.

18. The method of claim 17, wherein the location-related data obtained from each energy detection device comprises at least one of a respective angular displacement or a respective energy intensity for the source within the field of view of each respective energy detection device.

19. The method of claim 18, wherein a known location in relation to the three-dimensional space for each of the plurality of energy detection devices is combined with at least one of the angular displacement for the source or the energy intensity for the source within the field of view of each of the plurality of energy detection devices to determine the location of the source during a perception frame.

20. The method of claim 19, further comprising:
determining a plurality of volumes in a space, wherein each volume in the space is determined by at least one of a respective angular displacement of the source or a respective energy intensity for the source within the field of view of a plurality of respective energy detection devices; and
determining the location of the source during the perception frame as the intersection of the plurality of volumes.

21. The method of claim 1, further comprising determining at least of one an angular position of the entity or an orientation of the entity by determining the locations of a plurality of sources of energy emission which are attached to the entity.

22. A system for identifying the location of an entity in a three-dimensional space comprising:
a source of energy emission, wherein the source is attached to the entity, and wherein the source modulates an energy emission according to a unique energy modulation pattern, wherein the source is a unique source;
an energy detection device which monitors the unique source, wherein the energy detection device obtains location-related data for the unique source; and
a means for analyzing the location-related data obtained from the energy detection device, wherein said means determines the location of the unique source, and wherein said means for analyzing location-related data is a data analysis engine.

23. The system of claim 22, wherein the energy detection device detects energy from the unique source during a perception frame, and wherein a first perception frame is followed by a second perception frame at a periodic perception frame rate.

24. The system of claim 23, wherein the unique source modulates the energy emission on and off according to the unique energy modulation pattern at a rate which is substantially synchronized with the perception frame rate of the energy detection device, and wherein over a plurality of perception frames the energy detection device receives the unique energy modulation pattern of the unique source.

25. The system of claim 24, wherein the unique source synchronizes the energy emission with the perception frame rate of the energy detection device by receiving a synchronization signal from at least one of the energy detection device, the data analysis engine, or a source of a synchronization signal which is synchronized with the energy detection device, and
wherein the synchronization signal comprises at least one of an infrared signal, a magnetic signal, a radio frequency signal, a laser signal, an electromagnetic signal, or an audio signal.

26. The system of claim 23, wherein the unique source modulates the energy emission on and off according to the unique energy modulation pattern at a rate which is not synchronized with the perception frame rate of the energy detection device;
wherein the energy detection device determines when a received modulated energy emission from the unique source which is received by the energy detection device conforms to the energy modulation pattern of the unique source; and
wherein over a plurality of perception frames the energy detection device receives the unique energy modulation pattern of the unique source.

27. The system of claim 26, wherein the energy detection device determines that the received energy modulation pattern received from the unique source conforms to the energy modulation pattern of the unique source by at least one of determining that the received energy modulation pattern conforms to a previously detected energy modulation pattern of the unique source or by determining that the received energy modulation pattern detected from the unique source is an unambiguous energy modulation pattern.

28. The system of claim 22, further comprising a plurality of energy detection devices, wherein each energy detection device of the plurality of energy detection devices detects energy from the unique source within a field of view of the energy detection device, and wherein at least two of the energy detection devices have an overlapping field of view.

29. The system of claim 28, wherein each energy detection device of the plurality of energy detection devices determines location-related data of the unique source by determining at least one of an angular displacement or an energy intensity for the unique source within the field of view of the energy detection device.

30. The system of claim 29, wherein the data analysis engine combines a known location in relation to the three-dimensional space for each of the plurality of energy detection devices with at least one of the angular displacement for the unique source or with the energy intensity for the unique source within the field of view of each of the plurality of energy detection devices to determine the location of the unique source during the perception frame.

31. The system of claim 30, wherein the data analysis engine determines at least one of a path of movement of the unique source or an equation of motion of the unique source based on the location of the unique source during a plurality of perception frames.

32. The system of claim 31, wherein the data analysis engine extrapolates an extrapolated current position of the unique source based on at least one of a past location of the unique source, the path of movement of the unique source, or the equation of motion of the unique source.

33. The system of claim 31, wherein the data analysis engine determines that a newly identified source is the same as a previously identified unique source based on the location of the newly identified source and the extrapolated current position of the unique source.

34. The system of claim 22, wherein the unique source emits energy comprised of infrared light and wherein the energy detection device detects energy comprised of infrared light.

35. The system of claim 22, wherein a single period of time wherein energy may be emitted or energy may not be emitted from the unique source to signal a single bit in the energy emission pattern is an energy emission event; and
wherein the unique source is modulated on by at least one of emitting energy for greater than an on-modulation threshold period of time during the energy emission event or emitting energy at greater than an on-modulation threshold level of energy during the energy emission event; and
wherein the source is modulated off by at least one of emitting energy for less than an off-modulation threshold period of time throughout the duration of the energy emission event or emitting energy at less than an off-modulation threshold level of energy throughout the duration of the energy emission event.
